(19) United States
(12) Patent Application Publication
(10) Pub. No.: US 2005/0201917 A1
(43) Pub. Date: Sep. 15, 2005

(54) Partially crystalline mesostructured material consisting of cerium oxide, of zirconium oxide or of titanium oxide and comprising an element in solid solution in said oxide

(76) Inventor: Jean-Yves Chane-Ching, Eaubonne (FR)

Correspondence Address: Jean-Louis Seugnet;Intellectual Property Dept., Rhodia Inc, 259 Prospect Plains Raod, CN-7500, Cranbury, NJ, 08512-7500, US

(21) Appl. No.: 10/510,843

(22) PCT Filed: Apr. 10, 2003
(86) PCT No.: PCT/FR03/01138

§ 371 Date: Apr. 28, 2005

(30) Foreign Application Priority Data
Apr. 11, 2002 (FR) 02/04521

(51) Int. Cl. C01G 23/047

(52) U.S. Cl. 423/263; 423/608; 423/610; 428/402

(57) ABSTRACT

The invention relates to a partially crystalline mesostructured material which consists essentially of a compound chosen from cerium oxide, zirconium oxide, titanium oxide or a mixture of these compounds, and which is characterized in that it comprises at least one element M in solid solution in said oxide. This material is obtained by means of a process in which (a) a partially crystalline mesostructured starting material is brought into contact with a solution of the element M which has a concentration of this element of at most 2 mol/l; and then (b) the material obtained after this process of bringing into contact with said solution is calcinated at a temperature of at most 500° C.; steps (a) and (b) being repeated, where appropriate, until a material having the desired content of element M is obtained. The material can be used as a catalyst.

The present invention relates to a novel partially crystalline ordered mesoporous or mesostructured material consisting of cerium oxide, zirconium oxide or titanium oxide.

In the strict sense of the term, “mesoporous” compounds are solids which have, within their structure, pores of a size which is intermediate between that of the micropores of materials of the zeolite type and that of macroscopic pores.

More specifically, the expression “mesoporous compounds” initially denotes a compound which comprises specifically pores of mean diameter of between 2 and 50 nm, referred to by the term “mesopores”. Typically, these compounds are compounds of the amorphous or paracrystalline silica type in which the pores are generally distributed randomly, with a very broad pore-size distribution.

As regards the description of such compounds, reference may in particular be made to Science, vol. 220, pp. 365-371 (1983) or else to the Journal of Chemical Society, Faraday Transactions, 1, vol. 81, pp. 545-548 (1985).

In addition, “structured” compounds are, for their part, compounds that have an organized structure and are characterized more precisely by the fact that they have at least one scattering peak in an X-ray or neutron radiation scattering plot. Such scattering plots and the method of obtaining them are in particular described in Small Angle X-Rays Scattering (Glatter and Kratky, Academic Press, London, 1982).

The scattering peak observed in this type of plot may be associated with a repeat length characteristic of the compound in question, which will be referred to in the rest of the present description using the term “spatial repeat period” of the structured system.

On the basis of these definitions, the term “mesostructured compound” is intended to mean a structured compound having a spatial repeat period of between 2 and 50 nm. The organized structure present in such a material will be referred to here using the term “mesostructure”.

The ordered mesoporous compounds constitute, for their part, a particular case of mesostructured compounds. These are in fact mesoporous compounds that have an organized spatial arrangement of the mesopores present in their structure, and that, consequently, effectively have a spatial repeat period associated with the appearance of a peak in a scattering plot.

The ordered mesoporous or mesostructured compounds comprising a mineral phase are well known and are of great interest, in particular in the field of catalysis, absorption chemistry or membrane separation.

In addition, it has recently been discovered that it is possible to synthesize ordered mesoporous or mesostructured materials using to a pathway similar to the conventional process of liquid crystal templating, but with the additional presence of nanoscale particless in the templating medium. This type of process, described in particular in patent application WO 01/32558, makes it possible to obtain mesostructures which incorporate, within their walls, at least some of the nanoscale particles introduced into the templating medium.

A process described in patent application WO 01/49606 is, moreover, known, which uses a process of liquid crystal templating starting with colloidal particles and which results in materials composed essentially of a cerium oxide, a zirconium oxide and/or a titanium oxide, and which specifically contain no additional element introduced so as to provide cohesion of these materials.

Now, there exists a need for materials of this type with further improved properties, for example for materials having improved reducibility.

In addition, it is also sought to obtain of materials of this type referred to as “doped”, i.e. comprising a metal element other than the metal element forming the oxide, in solid solution within the crystal lattice of said oxide. In fact, even though it is currently known how to synthesize metal oxide particles of very small size (in particular of the cerium oxide, titanium oxide or zirconium oxide type, less than 10 nm in size), it is not, on the other hand, known how to either dope such particles by incorporating them in metal elements in solid solution, or to directly synthesize doped oxides in the form of particles of sufficiently small size and/or with a suitable surface area such that their use in a templating process of the type of that of WO 01/32558 results in a thermally stable mesostructure being obtained.

The object of the present invention is to obtain materials which satisfy these needs.

In this aim, the material of the invention is a partially crystalline mesostructured material which consists essentially of a compound chosen from cerium oxide, zirconium oxide, titanium oxide or a mixture of these compounds, and it is characterized in that it comprises at least one element M in solid solution in said oxide.

In addition, the invention relates to a process for preparing such a material, which is characterized in that it comprises the following steps:
(a) a partially crystalline mesostructured material consisting essentially of a compound chosen from cerium oxide, zirconium oxide, titanium oxide or a mixture of these compounds is brought into contact with a solution of the element M which has a concentration of this element of at most 2 mol/l;
(b) the material obtained after this process of bringing it into contact with said solution is calcinated at a temperature of at most 500° C.;
where appropriate, steps (a) and (b) are repeated until a material having the desired content of element M is obtained.

It has thus been demonstrated, unexpectedly, that the incorporation of doping metal cations in solid solution into particles of a mesostructured material can be carried out at relatively low temperature.

Moreover, the materials of the invention advantageously exhibit a stabilized specific surface area and improved reducibility.

Other characteristics, details and advantages of the invention will emerge even more completely on reading the description which follows, and also various concrete but nonlimiting examples intended to illustrate it.

In the remainder of the description, and unless otherwise indicated, the term “mesostructured” must be understood as applying both to the mesostructured materials and to the ordered mesoporous materials.

The term “rare earth” is intended to mean an element chosen from yttrium or the lanthanides, the lanthanides denoting all the elements whose atomic number is between 57 (lanthanum) and 71 (lutetium), inclusive. The term “transition metals” is intended to mean the elements included in groups IIIA to IIB inclusive of the Periodic Table of Elements. The Periodic Table of Elements to which reference is made is that published in the supplement to the bulletin of the Société Chimique de France [French Chemical Society] N^{o} 1 (January 1966).

The term “specific surface area” is intended to mean the BET specific surface area determined by nitrogen adsorption in accordance with the ASTM standard D 3663-78 established using the Brunauer-Emmeft-Teller method described in the periodical “The Journal of the American Chemical Society, 60, 309 (1938)”.

The material of the invention consists essentially of a compound chosen from cerium oxide CeO₂, zirconium oxide ZrO₂, titanium oxide TiO₂ or a mixture of these compounds in any proportions. As mixtures of these compounds, mention may be made most particularly of the CeO₂/ZrO₂ mixtures in which cerium is in the majority and the ZrO₂/CeO₂ mixtures in which zirconium is in the majority.

In the material of the invention, the abovementioned oxides are in the form of nanoscale particles. For the purpose of the present invention, the term “nanoscale particles” is intended to mean particles, preferably of spherical or isotropic morphology, in which at least 50% of the population has a mean diameter of between 1 et 10 nm, advantageously less than 6 nm, with these particles having a preferably monodisperse particle size distribution.

In particular, the term “nanoscale particles” can also denote, according to the invention, anisotropic particles of the rod type, on the condition that, for at least 50% of the population of these particles, the mean transverse diameter is between 1 and 10 nm and the length does not exceed 100 nm, with these particles having a preferably monodisperse particle size distribution.

The material of the invention is partially crystalline or, in other words, the nanoscale particles which constitute it are particles that are at least partially crystalline, i.e. they exhibit a degree of crystallinity of greater than 20%, preferably of at least 30%, it being possible for this degree to go up to 100% by volume. This degree of crystallinity can be calculated by means of the ratio of the area of a diffraction peak, measured by X-ray diffraction for a sample of the material according to the invention, to the area of the same diffraction peak measured for a controlled sample in which the constituent element of the particle is in the completely crystalline state and corrected for the absorption coefficients of the corresponding oxides. In this respect, it should be emphasized here that the “crystallinity” of the material, for the purposes of the invention, corresponds to a microscopic organization that is detectable in particular by diffraction (for example by wide-angle X-ray diffraction), and which is to be distinguished in particular from the “order” exhibited, at a more macroscopic level, by the mesostructure of the material.

The expression “material composed essentially of a cerium oxide, a zirconium oxide and/or a titanium oxide” is intended to mean a compound which contains specifically no additional element introduced so as to provide cohesion of the material. In particular, the materials composed essentially of a cerium oxide, a zirconium oxide and/or a titanium oxide, for the purposes of the present invention, are not materials comprising a mineral phase of the silica or alumina type playing the role of binder between cerium oxide, zirconium oxide and/or titanium oxide particles.

The essential characteristic of the material of the invention is that it contains an element M in solid solution in the constituent oxide of the material, i.e. in the cerium oxide, the zirconium oxide and/or the titanium oxide. This element M is in the state of a cation, generally in solid solution, of insertion and/or of substitution, within the crystalline structure of the oxide.

The expression “element in solid solution within an oxide” is intended to mean the presence of this element as a cation, in the capacity of an insertion and/or substitution cation, within a crystalline oxide characteristically playing the role of a host crystal lattice, said cation of the element M generally representing strictly less than 50 mol % of the total amount of metal cations in the oxide (cations of the oxide metal+cations of the metal M), i.e. the cation incorporated in solid solution is preferably a minor cation with respect to the constituent cations of the metal oxide in which it is incorporated in solid solution, the content of this cation of the element M possibly reaching, however, 50% in certain cases. A crystalline oxide which incorporates cations in solid solution preserves the structure of the crystalline oxide in the pure state, it being possible for slight modifications of the lattice parameters to be observed, however, for example in agreement with Vegard's law. A crystalline oxide which incorporates cations in solid solution generally, as a result, exhibits an X-ray diffraction plot similar to that of the pure mixed oxide, with a more or less substantial shift of the peaks.

Generally, the element M is chosen from rare-earth elements and the transition metals which may be capable of being incorporated in cationic form in solid solution within a cerium oxide, a zirconium oxide and/or a titanium oxide. However, the metal M may be chosen more specifically according to the nature of the metal oxide within which it is incorporated in solid solution. It will be noted that the amount of metal M that can be introduced in solid solution within the oxide depends on the nature of said metal M and on the nature of the element constituting said oxide.

Thus, when the material consists of cerium oxide, the element M present in solid solution may, in general, be chosen from rare-earth elements other than cerium. In this case, the metal M may be more particularly lanthanum, yttrium, neodymium, praseodymium, dysprosium or europium. The element M may also be chosen from the transition metals that may be capable of being incorporated in cationic form in solid solution within a cerium oxide, in particular zirconium, manganese and titanium. When the doping metal M represents zirconium or a rare-earth element other than cerium, the amount of cations of the metal M that can be incorporated in solid solution can represent a value such that the M/Ce molar ratio is at most 1. When the doping metal M represents titanium, the amount of titanium that can be incorporated in solid solution can represent a value such that the Ti/Ce molar ratio is at most 0.5.

When the material consists of zirconium oxide, the metal M present in solid solution may be chosen from cerium and rare-earth elements other than cerium. In this case, M may be advantageously cerium, lanthanum, yttrium, neodymium, praseodymium, dysprosium or europium. M may also be chosen from the transition metals that may be capable of being incorporated in cationic form in solid solution within a zirconium oxide. When the doping metal M represents cerium or another rare-earth element, the amount of cations of the metal M that can be incorporated in solid solution can represent a value such that the M/Zr molar ration is at most 1.

When the material consists of titanium oxide, the metal M present in the cationic state in solid solution may also be chosen from rare-earth elements and the transition metals which may be capable of being incorporated in solid solution within a titanium oxide. The metal M may be more particularly manganese, tin, vanadium, niobium, molybdenum or antimony.

Finally, according to a particular embodiment, the element M is chosen from titanium, cerium, zirconium, manganese, lanthanum, praseodymium and neodymium, said element M being different from the element constituting the oxide of the material (cerium oxide, zirconium oxide or titanium oxide).

According to a variant of the invention, the material may also comprise metal cations of the metal M or of an alkali metal or alkaline-earth metal and/or clusters based on the metal M or on an alkali metal or alkaline-earth metal and/or crystallites of these same elements. These cations, these clusters or these crystallites are dispersed, preferably evenly, at the surface of the oxide constituting the material. The crystallites may be, for example, crystallites of TiO₂ in anatase form, crystallites of ZrO₂ and, for the alkali metals or alkaline-earth metals, hydroxides, carbonates, hydroxycarbonates or other salts.

The term “cluster based on the metal M” is intended to mean a polyatomic entity less than 2 nm, preferably less than 1 nm, in size, comprising at least atoms of the metal M in oxidation state 0 or in a higher oxidation state (typically, these are clusters based on oxide and/or hydroxide species of the metal M, for example polyatomic entities within which several atoms of the metal M are linked to one another via —O— or —OH— bridges, it being possible for each of the atoms of the metal M to be linked to one or more —OH groups). This variant can be applied in particular to the case where the metal M is zirconium, manganese or alternatively a rare-earth element (in particular lanthanum, yttrium, neodymium, praseodymium, dysprosium or europium).

When the cations, clusters and/or crystallites of an alkali metal or alkaline-earth metal are dispersed at the surface of the oxide constituting the material, as has just been described, the amount of this alkali metal or alkaline-earth metal in this form, expressed in moles relative to the moles of the constituent oxide(s) and of metal M, is generally between 2% and 30%.

In the case of cations, clusters and/or crystallites of metal M, the ratio expressed in moles of M relative to the moles of the constituent oxide(s) and of metal M can vary between 2% and 80%.

Advantageously, the mesostructured materials of the present invention are solids exhibiting, at least on a local level, one or more mesostructure(s) chosen from: mesoporous mesostructures of three-dimensional P63/mmc hexagonal symmetry, of two-dimensional P6mm hexagonal symmetry, or of three-dimensional Ia3d, Im3m or Pn3m cubic symmetry; mesostructures of vesicular, lamellar or vermicular type or mesostructures of L3 symmetry referred to as sponge phase. As regards the definition of these various symmetries and structures, reference may be made, for example, to the articles in Chemical Materials, Vol. 9, in No. 12, pp. 2685-2686 (1997), in Nature, Vol. 398, pp. 223-226 (1999), or in Science, vol. 269, pp. 1242-1244 (1995).

Moreover, the pores observed within the mesostructure of the material of the invention are generally such that at least 50% of the population of the pores present within the structure have a mean diameter of between 2 and 10 nm. In addition, the mean thickness of the walls of the structure of said material is between 4 and 10 nm.

The materials of the invention generally exhibit, at the end of their preparation, a high BET specific surface area, of at least 600 m²/cm³, more particularly of at least 800 m²/cm³ and even more particularly of at least 1000 m²/cm³.

In the specific case of a material consisting of cerium oxide and in which M is praseodymium, this surface area may be at least 100 m²/g, more particularly at least 120 m²/g, and even more particularly at least 140 m²/g. In the specific case of a material consisting of cerium oxide and in which M is titanium, this surface area may be at least 100 m²/g, more particularly at least 125 m²/g and even more particularly at least 150 m²/g.

The pore volume of the materials of the invention is generally at least 0.10 cm³/g, more particularly at least 0.15 cm³/g, and even more particularly at least 0.20 cm³/g.

One of the advantages of the materials of the invention based on cerium oxide is their reducibility. This “reducibility” of a material according to the invention can be demonstrated by treating the material with hydrogen and analyzing the rate of conversion of the cerium in oxidation state IV initially present, to cerium in oxidation state III in the material obtained after treatment, according to the overall reaction below:
2CeO₂+H₂→Ce₂O₃+H₂O

The reducible nature of a material according to the invention can thus in particular be quantified by the rate of conversion measured at the end of a “TPR” protocol, disclosed below:
in an Altamira AMI-1 device equipped with a silica reactor, a sample of 100 mg of the solid to be tested is placed, at ambient temperature (generally between 15° C. and 25° C.), under a stream of gas made up of a hydrogen/argon mixture containing 10% of hydrogen by volume, at a flow rate of 30 ml per minute;
the temperature is raised to 900° C. at a constant rate of temperature increase of 10° C. per minute. Using a thermal conductivity detector at 70 mA, the amount of hydrogen taken up by the material is determined from the missing area of the hydrogen signal from the baseline at ambient temperature to the baseline at 900° C.

At the end of such a test, a rate of conversion of the cerium IV species initially present that is at least 30% is generally measured, this rate of conversion being advantageously at least 40%, more preferably at least equal to 50%.

It should be noted, moreover, that the cerium reduction peak determined by the protocol above is centered on temperatures of at most 450° C., preferably of at most 400° C., and even more preferably of at most 375° C.

The process for preparing the material of the invention will now be described.

As indicated above, the first step in this process consists in bringing a starting material into contact with a solution of the element M. The starting material is a partially crystalline mesostructured material consisting essentially of a compound chosen from cerium oxide, zirconium oxide, titanium oxide or a mixture of these compounds, and which can be prepared by any known means. As a process for preparing such a starting material, mention may be made more particularly of that described in patent application WO 01/49606, the teaching of which may be used as a reference, and the main characteristics of which are recalled below.

This preparation process comprises the steps consisting in forming an initial dispersion comprising colloidal nanoscale particles that are at least partially crystalline, and a templating agent; then in concentrating the dispersion obtained so as to obtain a solid by templating and gradual consolidation of the colloidal particles; and, finally, in eliminating the templating agent from the solid obtained. Said colloidal nanoscale particles are particles based on at least one compound of a metal chosen from cerium, zirconium or titanium, that are preferably chosen from particles of cerium oxide CeO₂, zirconium oxide ZrO₂ and titanium oxide TiO₂.

According to a variant of the process of the invention, the colloidal particles of the cerium, titanium or zirconium compound are functionalized with a surface agent of formula X—A—Y. The surface agent may also be in free form within the dispersion comprising the particles.

This surface agent is an organic compound in which A is an optionally substituted, linear or branched alkyl group which may, for example, comprise from 1 to 12 carbon atoms, preferably between 2 and 8 carbon atoms.

The function X is a complexing function for the metal cation of the colloid of the colloidal dispersion of the cerium, titanium or zirconium compound. The term “complexing function” is intended to mean a function which allows the formation of a complexing bond between the cation of the colloid, for example the cerium cation, and the surface agent. This function may be a function of the phosphonate —PO₃²⁻, phosphate —PO₄²⁻, carboxylate —CO₂⁻, sulfate —SO₄²⁻or sulfonate −SO₃² type, for example.

The function Y is an amine or hydroxyl function. It may be an amine function of the —NH₂, —NHR₁, —NR₂R₁ or —NH₄⁺ type, R₁ and R₂, which may be identical or different, denoting a hydrogen or an alkyl group comprising from 1 to 8 carbon atoms. It may also be an OH function. Among the agents containing OH functions, mention may be made, for example, of glycolic acid, gluconic acid, lactic acid, hydroxybenzoic acid, and disodium glyceryl phosphate.

Among the surface agents which are particularly suitable, mention may be made of amino acids, and in particular aliphatic amino acids. Mention may in particular be made of the amino acids constituting proteins of structure R—CH(NH₂)—COOH where R is an aliphatic radical. By way of example, mention may be made of leucine, alanine, valine, isoleucine, glycine and lysine.

The preferred surface agent is aminohexanoic acid.

Advantageously, the amount of surface agent used to functionalize the compound of the dispersion is expressed by the ratio Rb, determined by means of the following formula:

$$Rb = \frac{Number of moles of function X}{\begin{matrix}Number of moles of cerium oxide , \\ of titanium oxide or of zirconium oxide\end{matrix}}$$

The ratio Rb is advantageously between 0.1 and 0.5.

Preferably, the functionalization of the cerium, titanium or zirconium compound is carried out by bringing a dispersion of said compound into contact with the surface agent.

When the medium of the dispersion formed during the first step is an acidic medium, the templating agent used is a nonionic surfactant of block copolymer type, preferably chosen from poly(ethylene oxide)-poly(propylene oxide)-poly(ethylene oxide) triblock copolymers or grafted poly(ethylene oxide)s. When the medium of the dispersion formed during the first step is a basic medium, the templating agent used is then a surfactant of the primary alkylamine type.

The solution of the element M used in the case of the process according to the invention is usually an aqueous solution based on salts of this element. The inorganic acid salts such as nitrates, sulfates or chlorides may be chosen. The organic acid salts, and in particular the saturated aliphatic carboxylic acid salts or the hydroxycarboxylic acid salts, may also be used. By way of examples, mention may be made of formates, acetates, propionates, oxylates or citrates. It is, however, possible to use an aqueous or aqueous-alcoholic solution comprising cations of the metal M in the complexed state, or else a solution, generally in an anhydrous organic solvent medium, comprising an alkoxide of the metal M. In the case of titanium, a titanium alkoxide in acidified aqueous-alcoholic medium may more particularly be used.

The solution which is brought into contact with the starting material has a concentration of this element M which is at most 2M, preferably at most 1.2M. A higher concentration risks preventing the formation of a solid solution of the element M in the oxide constituting the material.

The process of bringing into contact may be carried out by immersing the starting mesostructured material in a solution comprising the element M, and then subjecting the medium obtained to centrifugation. Generally, the centrifugation is carried out at a rate of 2000 to 5000 rpm, for a period generally not exceeding 30 minutes.

According to a particular embodiment, the process of bringing into contact is carried out by dry impregnation. Dry impregnation consists in adding to the product to be impregnated a volume of an aqueous solution of the element M which is equal to the pore volume of the material to be impregnated.

The solid obtained at the end of the first step of the process is then subjected to a calcination. This calcination step is essentially intended to effect an at least partial incorporation of the cations of the element M in solid solution within the oxide constituting the mesostructured material. To this effect, this calcination is carried out at a temperature at least equal to 300° C., this temperature being preferably at least equal to 350° C., but at most 500° C. or 400° C. Higher temperatures are not required as regards the incorporation of the cations of the element M within the oxide. In this respect, it should be clearly underlined that the process of the present invention makes it possible, surprisingly, to incorporate insertion or substitution metal cations in solid solution within the metal oxide of the material at low temperatures, which makes it possible in particular to obtain mesostructured materials having very large specific surface areas. Particularly advantageously, the calcination step can be carried out by subjecting the solid to a temperature gradient, from an initial temperature of between 15 and 95° C., to a final temperature of between 350° C. and 500° C., advantageously with a temperature increase of between 0.5° C. per minute and 2° C. per minute, and with one or more successive stages where the temperature is maintained at intermediate temperatures, preferably of between 350 and 500° C., for varying periods of time, generally of between 1 hour and 24 hours.

Optionally, the preparation process of the invention may comprise a drying step prior to the calcination. In this case, this pre-drying is generally carried out as slowly as possible, in particular so as to promote ion exchanges. To this effect, the drying is most commonly carried out at a temperature of between 15 and 80° C., preferably at a temperature of less than 50° C., or even less than 40° C., and advantageously at ambient temperature. This drying can be carried out under an inert atmosphere (nitrogen, argon) or under an oxidizing atmosphere (air, oxygen) according to the compounds present in the material. When the metal M is introduced within the material in the form of an alkoxide, the drying is advantageously carried out under a moisture-free atmosphere.

According to a particularly advantageous embodiment, the process of the invention may comprise, following steps (a) and (b), one or more subsequent cycles of bringing into contact/calcination implementing steps of type (a) and (b), carried out on the solid obtained at the end of the preceding cycle. By carrying out this type of process with several successive cycles of bringing into contact/calcination, very good incorporation of the element M in solid solution within the oxide particles is achieved. These cycles are repeated until a material having the desired content of element M is obtained. It is also possible to envision the implementation of several cycles of bringing into contact/calcination using different M-type doping elements, by means of which materials consisting of oxides doped with several metal elements in solid solution can be obtained.

To prepare materials according to the variant described above in which cations, clusters and/or crystallites of the metal M or of an alkali metal or alkaline-earth metal are dispersed at the surface of the oxide constituting the material, solutions of this element (M or alkali metals or alkaline-earth metals) at high concentrations, for example of at least 1.5M, are used and/or the step of bringing into contact with this solution is repeated after saturation of the oxide constituting the material in the form of a solid solution, with this element.

For the alkali metals or alkaline-earth metals, solutions of inorganic acid salts such as nitrates, sulfates or chlorides are generally used. The organic acid salts, and in particular the saturated aliphatic carboxylic acid salts or hydroxycarboxylic acid salts, can also be used. By way of examples, mention may be made of formates, acetates, propionates, oxalates or citrates.

Given their high specificity and their particular properties in acidity-alkalinity terms, possibly combined with oxidizing properties, the materials of the present invention may prove to be particularly useful as heterogeneous catalysts, in particular as heterogeneous acid, basic or redox catalysts.

Specifically, it should be emphasized that, among these catalysts, the materials of the invention based on particles of cerium oxide incorporating in solid solution zirconium or a rare-earth element, and more particularly praseodymium, or, conversely, the materials based on particles of zirconium oxide incorporating cerium in solid solution, proved to be particularly advantageous insofar as they have considerable oxygen storage capacities. The materials of the invention based on particles of cerium oxide incorporating zirconium in solid solution exhibit moreover, in general, considerable thermal stability.

Furthermore, the materials of the invention, in particular the materials based on particles of cerium oxide incorporating cations of zirconium or of a rare-earth element (other than cerium) in solid solution, can prove to be particularly useful as carriers for catalytic species, in particular metal species of the noble metal type (platinum for example).

These various uses constitute another subject of the present invention. The invention therefore also relates to the catalysts which contain catalytic species on a carrier which is a material of the type such as that which was described above or a material which can be obtained by a process of the type such as that also described above. This catalytic species may be precious metals such as platinum, palladium or rhodium, for example.

Examples will now be given.

### EXAMPLE 1

This example concerns a mesostructured material consisting of cerium oxide and also comprising zirconium.

The mesostructured material consisting of cerium oxide was first of all prepared according to the process described in example 1 of WO-A-01/49606.

2 g of this mesostructured material was introduced into 50 ml of zirconyl nitrate solution containing 1.5 mol/l of zirconium (NO3/Zr molar ratio=1.3). This medium was placed at 25° C. for 1 hour with stirring.

The dispersion produced was then subjected to centrifugation at 4500 rpm for 15 minutes.

The centrifugation pellet was recovered and was then dried by leaving it in the open air at 25° C. for 16 hours.

The solid obtained was then placed in an oven at 80° C. for 8 hours.

The solid was then gradually brought to 400° C. in air at a rate of temperature rise of 1° C./min. The solid was then left at 400° C. for 6 hours, and the temperature was then allowed to gradually decrease to 25° C.

By means of X-ray fluorescence analysis, the following molar proportions of the Ce and Zr cations within the material obtained following these various steps was determined:
(Ce:Zr)=(0.88:0.12).

By means of BET analysis, the specific surface area of the product obtained was measured at 105 m²/g and the observed pore distribution was centered on 4 nm with a pore volume of 0.145 cm³/g.

By means of X-ray diffraction, a spectrum was observed that was very similar to that of a pure cerium oxide, with peaks that are very slightly shifted toward small distances (5.40 Å), which characterizes the presence of zirconium in solid solution in the cerium oxide.

### EXAMPLE 2

This example concerns a mesostructured material consisting of cerium oxide and also comprising praseodymium.

A solution of Pr(NO₃)₃ containing 1.21 M of Pr was prepared by adding demineralized water to 51.9 ml of solution of Pr(NO₃)₃ containing 2.91 M of Pr, of density 1.73, and with a praseodymium oxide content of 28.6%, until a final volume of 125 cm³ was obtained.

The mesostructured material of example 1 was, moreover, used.

8 g of this material (i.e. 46.51 millimol of Ce) were impregnated with 5.76 cm³ of solution of the previously prepared solution of praseodymium nitrate containing 1.21 M of Pr (i.e. 6.97 millimol of Pr). The molar ratio (Pr/Ce) was then equal to 0.15. The product was dried at ambient temperature for 16 hours, and then at 80° C. for 8 hours. The product was then calcinated in air at 400° C. with a temperature rise of 1° C./min and a temperature hold of 6 hours.

The impregnation and thermal treatment operation was then repeated. The final molar ratio (Pr/Ce) was then equal to 0.3.

By means of X-ray diffraction, a spectrum was observed that was very similar to that of a pure cerium oxide, with peaks that were very slightly shifted toward large distances (lattice parameters of 5.45 Å), which characterizes the presence of praseodymium in solid solution in the cerium oxide.

The BET specific surface area was determined to be equal to 123 m²/g.

A pore distribution centered on a pore diameter of 6 nm was observed.

The pore volume was determined to be equal to 0.21 cm³/g.

Following the TPR test, a reducibility peak at very low temperature centered at a temperature of 350° C. was observed. The cerium IV conversion rate was 44%.

### EXAMPLE 3

This example concerns a mesostructured material consisting of cerium oxide and also comprising titanium.

An acidified butyl titanate solution was prepared by dissolving 20.65 g of Ti(OBu)₄ containing 23.45% of TiO₂ in 15 cm³ of ethanol, and 8 cm³ of 15 M HNO₃, and making up the volume to 50 cm³ with ethanol.

4 g of mesoporous product of example 1, i.e. 23.25 millimol of Ce, calcinated at 400° C. for 6 hours, were impregnated with 2.91 cm³ of solution of the previously prepared titanium solution (i.e. 3.49 millimol of Ti). The molar ratio (Ti/Ce) was then equal to 0.15. The product was dried at ambient temperature for 16 hours, and then at 80° C. for 6 hours. The product was then calcinated in atmospheric air at 400° C. with a temperature rise of 1° C./min and a temperature hold of 6 hours.

The impregnation and thermal treatment operation was then repeated. The final molar ratio (Ti/Ce) was then equal to 0.3.

By means of X-ray diffraction, a spectrum was observed that was very similar to that of a pure cerium oxide, with peaks that Were very slightly shifted toward small distances, which spectrum is characteristic of a solid solution.

The BET specific surface area was determined to be equal to 130 m²/g.

A pore distribution centered on a pore diameter of 6 nm was observed.

The pore volume was determined to be equal to 0.20 cm³/g.

1-17. (canceled)

18. A partially crystalline mesostructured material consisting essentially of a compound being cerium oxide, zirconium oxide, titanium oxide or a mixture of these compounds, and at least one element M in solid solution in said oxide.

19. The material as claimed in claim 18, having a degree of crystallinity greater than 20% by volume, optionally at least 30% by volume.

20. The material as claimed in claim 18, consisting essentially of cerium oxide and wherein said element M is a rare-earth element other than cerium, or a transition metal capable of being incorporated in cationic form in solid solution within a cerium oxide.

21. The material as claimed in claim 18, consisting essentially of zirconium oxide and wherein said element M is a rare-earth element or a transition metal capable of being incorporated in cationic form in solid solution within a zirconium oxide.

22. The material as claimed in claim 18, consisting essentially of titanium oxide and wherein said element M is a rare-earth element or a transition metal capable of being incorporated in cationic form in solid solution within a titanium oxide.

23. The material as claimed in claim 20, wherein the element M is titanium, cerium, zirconium, manganese, lanthanum, praseodymium or neodymium, said element M being different from the element constituting said oxide.

24. The material as claimed in claim 21, wherein the element M is titanium, cerium, zirconium, manganese, lanthanum, praseodymium or neodymium, said element M being different from the element constituting said oxide.

25. The material as claimed in claim 22, wherein the element M is titanium, cerium, zirconium, manganese, lanthanum, praseodymium or neodymium, said element M being different from the element constituting said oxide.

26. The material as claimed in claim 20, wherein said element M is a rare-earth element and zirconium with a M/Ce molar ratio of at most 1.

27. The material as claimed in claim 26, wherein said element M is titanium with a Ti/Ce molar ratio of at most 0.5.

28. The material as claimed in claim 18, exhibiting, at least on a local level, at least one mesostructure being a mesoporous mesostructure of three-dimensional hexagonal symmetry P63/mmc, of two-dimensional hexagonal symmetry P6mm, or of three-dimensional cubic symmetry Ia3d, Im3m or Pn3m; a mesostructure of vesicular, lamellar or vermicular type; or a mesostructure of L3 symmetry referred to as sponge phase.

29. The material as claimed in claim 18, further comprising metal cations and/or clusters and/or crystallites of the metal M or of an alkali metal or alkaline-earth metal, dispersed at the surface of said oxide.

30. The material as claimed in claim 18, having a BET specific surface area of at least 600 m²/cm³, optionally of at least 1000 m²/cm³.

31. The material as in claim 18, consisting of particles of said oxide of spherical or isotropic morphology, in which at least 50% of the population has a mean diameter of between 1 and 10 nm.

32. The material as claimed in claim 18, wherein the pores within the mesostructure of said material are such that at least 50% of the population of the pores present within the structure have a mean diameter of between 2 and 10 nm.

33. The material as claimed in claim 32, wherein the structure of said material has walls whose mean thickness is between 4 and 10 nm.

34. A process for preparing a material as defined in claim 18, wherein it comprising the following steps:
(a) a partially crystalline mesostructured material consisting essentially of a compound being cerium oxide, zirconium oxide, titanium oxide or a mixture of these compounds is being added to a solution of the element M whose concentration is of at most 2 mol/l; and
(b) calcinating the product obtained in step a) at a temperature of at most 500° C.; and, optionally,
c) repeating steps (a) and (b) until a material having the desired content of element M is obtained.

35. The process as claimed in claim 34, wherein step (a) is carried out by dry impregnation.

36. A catalyst having catalytic species on a material as claimed in claim 18.
